(19) United States
(12) Patent Application Publication
(10) Pub. No.: US 2026/0265030 A1
(43) Pub. Date: Sep. 10, 2026

(54) METHOD FOR AUTOMATICALLY CONTROLLING AN INDUSTRIAL TRUCK, AND INDUSTRIAL TRUCK

(71) Applicant: HUBTEX MASCHINENBAU GMBH & CO. KG, FULDA (DE)

(72) Inventor: MORITZ LEINBERGER, DIPPERZ (DE)

(73) Assignee: HUBTEX MASCHINENBAU GMBH & CO. KG, FULDA (DE)

(21) Appl. No.: 19/164,587

(22) PCT Filed: Mar. 12, 2024
(86) PCT No.: PCT/EP2024/056501

§ 371 Date: Sep. 12, 2025

(30) Foreign Application Priority Data
Mar. 15, 2023 (DE) 10 2023 106 517.3

(51) Int. Cl. B66F 9/06; B66F 9/075

(52) U.S. Cl. CPC B66F 9/063; B66F 9/0755

(57) ABSTRACT

A method for automatically controlling an industrial truck when entering a rack aisle and when driving along at least one rack of a racking system. The method includes driving over a predefined entry region of at least one rack aisle, detecting an environment adjacent to the industrial truck via at least one optical and/or run-time measuring sensor, and, upon a detection of at least one predefined feature of an entrance into a selected rack aisle of the at least one rack aisle, enabling an automatic alignment of the industrial truck into a predefined position relative to the selected rack aisle.

### CROSS REFERENCE TO PRIOR APPLICATIONS

This application is a U.S. National Phase application under 35 U.S.C. § 371 of International Application No. PCT/EP2024/056501, filed on Mar. 12, 2024 and which claims benefit to German Patent Application No. 10 2023 106 517.3, filed on Mar. 15, 2023. The International Application was published in German on Sep. 19, 2024 as WO 2024/189002 A1 under PCT Article 21 (2).

### FIELD

The present invention relates to a method for automatically controlling an industrial truck when entering a rack aisle and/or when driving on a passageway along at least one rack wall. The present invention also relates to an industrial truck for performing such a method.

### BACKGROUND

In aisles between or along racks, so-called rack aisles, which are generally chosen to be as narrow as possible in order to optimize the use of available space, even comparatively small deviations in the movement of the industrial truck from an ideal course may result in collisions between the industrial truck and the racks or their lateral boundaries. This in turn may result in damage to both the industrial truck and to the racks, including complete destruction and thus loss of use. Particularly when transitioning from an open area into such a rack aisle, the so-called entry region, it is not uncommon for there to be collisions with racks or their lateral boundaries due to inaccuracies in the alignment of the industrial truck. It should be clear that the term rack aisles is to be understood here as any laterally delimited paths on which industrial trucks are restricted in their freedom of movement for storage and retrieval, in particular also storage aisles or open storage aisles.

A number of attempts have therefore already been made to resolve the problem regarding entry into such rack aisles. These improvements were initially structural, in particular by using mechanical guides, for example, in the form of reinforced impact protection on lateral regions of the rack, especially in the entry regions. Although this did provide effective protection for the racks, it has been shown that, in the case of collisions with such impact protection on structures or racks, the extent of damage to the vehicle was comparatively significantly greater. Improvements to vehicles have therefore been pursued so that in particular methods and industrial trucks are now known in which automatic control, in particular automatic steering, of the industrial truck is provided for driving into and along rack aisles in order to facilitate the operation of the industrial truck in or along rack aisles. Guide-wire guidance systems have in particular become established for such automatic steering of industrial trucks in which a predefined guide wire (whether physically installed in the floor of the building or virtually generated) is detected by the vehicle via a path detection system and the vehicle is guided automatically along a path.

Such a path detection system, industrial truck, and method for automatically steering an industrial truck along a guide wire when entering and driving on rack aisles is described, for example, in WO 2022/199912 A1.

Although the automatic control of industrial trucks, in particular steering and/or driving, with the aid of a guide-wire guidance within or along rack aisles has proven itself in principle, it has been shown in practice that, in particular when approaching and/or entering a rack aisle, the industrial truck may become misaligned with the guide wire, or the center of the aisle, for various reasons such as, for example, the presence of dirt, damage or ruts, or driving dynamics, so that the operator still needs to pay very close attention in order to avoid collisions, and may even have to intervene in the automatic steering process if necessary.

### SUMMARY

An aspect of the present invention is therefore to provide a method for automatically controlling an industrial truck when entering a rack aisle and/or when driving on a passageway along at least one rack wall with respect to this disadvantage, and to provide an improved industrial truck for performing the method.

In an embodiment, the present invention provides a method for automatically controlling an industrial truck when entering a rack aisle and when driving along at least one rack of a racking system. The method includes driving over a predefined entry region of at least one rack aisle, detecting an environment adjacent to the industrial truck via at least one optical and/or run-time measuring sensor, and, upon a detection of at least one predefined feature of an entrance into a selected rack aisle of the at least one rack aisle, enabling an automatic alignment of the industrial truck into a predefined position relative to the selected rack aisle.

### BRIEF DESCRIPTION OF THE DRAWINGS

The present invention is described in greater detail below on the basis of embodiments and of the drawings in which:

FIG. 1 shows a racking system from above, with an industrial truck according to the present invention for performing the method according to the present invention;

FIG. 2 shows a racking system from above, with an industrial truck according to the present invention for performing the method according to the present invention;

FIG. 3 shows a racking system from above, with an industrial truck according to the present invention for performing the method according to the present invention;

FIG. 4 shows a racking system from above, with an industrial truck according to the present invention for performing the method according to the present invention;

FIG. 5 shows the industrial truck performing the method according to the present invention at another racking system; and

FIG. 6 shows the industrial truck performing the method according to the present invention at another racking system.

### DETAILED DESCRIPTION

The method according to the present invention for automatically controlling an industrial truck when entering and driving on an aisle along at least one rack wall provides that, during driving on a predefined entry region of at least one rack aisle, an optical and/or run-time detection of an environment adjacent to the industrial truck, in particular of objects located adjacent to the industrial truck, is effected via at least one optical and/or run-time detection sensor arranged on the industrial truck.

According to the present invention, detection of the environment is effected optically and/or by run-time measurement. In the case of optical detection, the environment adjacent to the industrial truck is monitored by an optical detection element. An optical detection element may, for example, be a camera. The camera may provide 2D or 3D detection. In the case of detection by run-time measurement, detection may in particular be effected by a lidar, an electromagnetic radar sensor, and/or an acoustic ultrasonic sensor. Laser beams or electromagnetic pulses or waves are in this case, for example, emitted into the environment and, upon their being reflected on an object, the time until they are received back is measured, so that a distance from the object can optionally be determined therefrom. The sensors can, for example, be arranged and aligned on the industrial truck so that they enable detection laterally and/or ahead of the industrial truck, in particular within the entry region.

An entry region is here to be understood in particular as the region that forms a transition from an open area into an aisle arranged between two rack walls, or also from an open area into an adjacent aisle leading along a single rack wall. This region is typically located at the front end of one or two rack walls, in particular in the interspace between the ends of two mutually adjacent rack walls, i.e., where the aisle begins.

The objects that can be detected via the at least one detection sensor may, for example, be the rack or the rack wall as such, a lateral boundary of the rack, or any other object, such as a pallet, goods or a person. It should be clear that although persons can also be detected as objects in the context of the aforementioned detection, the present detection system does not represent or even replace a personal protection system.

The present invention provides that, upon detection of at least one predefined, in particular geometric, feature of an entrance into a rack aisle, an automatic aligning of the industrial truck into a predefined position relative to the detected rack aisle is enabled.

The aforementioned features of an entrance that can be detected by the detection sensor may in particular be geometric designs, shapes or components, such as a wall, edge or corner of a rack, a lateral boundary or another body, that as such are characteristic of an entrance to a rack aisle and have previously been predefined for this purpose in a control system for performing the method. It may also be provided that an individual coding is arranged at each entrance to a rack aisle, for example, a barcode, that is optically detectable by the detection sensor. Such a barcode may serve, for example, as a link to a data set, and this data set may contain items of information relating to the respective rack aisle. This allows additional items of information relating to the respective rack aisle, or to the adjoining rack walls, to be retrieved immediately upon detection of such a coding. Items of information, or such a data set, may, for example, be retrieved from a database located on the vehicle or on the building.

The aforementioned position is in particular to be understood as an orientation, or alignment, of the industrial truck relative to the detected rack aisle entrance. If the industrial truck is realized as a sideloader, the industrial truck is in particular aligned in the longitudinal direction of travel with respect to the entrance. The industrial truck may in this case be aligned centrally with respect to the rack aisle or, in particular if it is a rack aisle that is significantly wider than the industrial truck, be aligned off-center, in particular at a predefined lateral distance from the rack wall.

Enabling here means that, depending on the setting or specification by the operator on the vehicle, either the industrial truck moves directly and automatically into the predefined position without confirmation by the operator, or alternatively, notification of the enabling is provided to the operator of the industrial truck, in particular visually, acoustically and/or haptically, or is indicated by another type of notification, so that the operator may manually select the automatic aligning of the industrial truck via a control command. The notification may be effected, for example, by the illumination of a pushbutton or display. In the latter case, the operator may then press the pushbutton or touch display to select and specify whether, and optionally into which rack aisle, the industrial truck is to be moved and aligned accordingly. An automatic moving of the industrial truck into the predefined position is in this case therefore only effected after confirmation by the operator. This makes it particularly quick and easy for the operator to drive into the rack aisle.

For the purpose of aligning, the industrial truck may be steered, accelerated and/or braked, in particular automatically. The industrial truck can, for example, be brought into a position which is parallel to the direction of travel and at a predefined distance from the at least one rack wall. The industrial truck may then be driven into an aisle (either manually by the operator or again automatically) in particular without touching the rack, for example, by travelling only straight ahead. Collisions when entering the rack aisle can thereby be effectively avoided. In the case of off-center entry, the lateral-wall boundary to which the industrial truck is to be aligned at a predefined distance may optionally be selected before the industrial truck is aligned. This in particular allows the storage and retrieval processes in the lateral region of the racks, i.e., within the aisle, to be optimized.

The method according to the present invention thus has the advantage that the automatic aligning of the industrial truck is in particular effected entirely independently of other devices such as, for example, a navigation or guide-wire guidance system, but solely on the basis of the objects detected as being adjacent to the industrial truck at any given time. This means that no need exists for either any complex installation or for an intensive maintenance of the system. The method according to the present invention can rather be used flexibly and individually at any racking system.

If the industrial truck detects a plurality of rack aisle entrances, the present invention can, for example, provide that the detected entrances are visually displayed to the operator for selection for automatic aligning of the industrial truck, and that the operator, via a control command, may manually select one of the entrances in front of which the automatic aligning of the industrial truck is to be effected. This makes it particularly quick and easy to drive into the intended rack aisle, especially if there is more than one rack aisle.

The present invention provides that, after an entrance has been detected, a distance and/or a positioning of the industrial truck relative to the detected entrance can, for example, be determined, in particular ascertained computationally. As the industrial truck is in this case approaching the entry region of a rack aisle, not only can the entrance as such be detected automatically, but the distance between the industrial truck and the entrance can be ascertained automatically. The distance between the industrial truck and a lateral boundary of the rack can, for example, be ascertained. Depending on the arrangement of the sensors on the vehicle and the design of the lateral boundary, a relative position of the industrial truck with respect to the lateral boundary, or to the entire entrance to the rack aisle, may thus be determined. The ascertaining of the distance, or of the position or alignment, of the industrial truck relative to the entrance may be effected, for example, by suitable detection sensors, in particular by those in which a run-time measurement is used for detection. The information obtained therefrom may be used for operational control of the automatic aligning of the industrial truck relative to the entrance so as to minimize the risk of the industrial truck colliding with the lateral boundary. The automatic aligning of the industrial truck may in particular be matched to predefined, individual specifications for entry.

In order to enable a particularly quick and easy entry into the rack aisle, it may be provided that, while the industrial truck is approaching an entrance, the distance from the entrance is detected and, if it is less than a predefined distance between the industrial truck and the detected entrance, automatic aligning of the industrial truck is enabled. Misinterpretations by the system can thereby be avoided. A selection by the operator, or the intention of the operator, to drive into the approached rack aisle may in particular be detected in a particularly safe and uncomplicated manner.

According to an advantageous design of the present invention, in order to avoid a collision with detectable objects, the present invention provides that, after at least one object located adjacent to the industrial truck has been detected, a distance or a position of the industrial truck relative to the at least one detected object is determined, in particular is ascertained computationally. Objects located in an entry region of a rack aisle or a maneuvering region of the vehicle may thus, for example, be detected, and an enabling for aligning the industrial truck and/or the aligning as such may be adapted depending on the detected object. In particular if permitted by the position of the detected object, an alignment of the industrial truck that is matched to the detected object and that in particular deviates from the usual movement may be effected, or alternatively, an enabling for aligning of the vehicle may be stopped and a warning signal issued to the operator.

A further design of the present invention provides that, after the industrial truck has been aligned in a predefined position relative to the detected rack aisle, the industrial truck can, for example, be additionally driven automatically into the aisle and, optionally, moved automatically further along the aisle. The entire process from the aligning of the industrial truck to driving into and on the rack aisle may thus be effected fully automatically, thereby affording the operator an easy approach to the rack.

It may be provided in this case that the industrial truck, after it has entered a rack aisle, is further controlled automatically, in particular at least steered, via a detection of the lateral distances from the rack walls or from a lateral boundary.

A further alternative advantageous design of the present invention provides that, after an entrance has been detected, a virtual center line extending along the center of the rack aisle is determined, in particular is ascertained computationally. The industrial truck, after entering an aisle, may thus be guided, in particular in its further course, on the basis of the virtual center line. This may in particular be effected to avoid an unwanted readjustment of the steering depending on the lateral distances from the lateral boundary of the rack aisle, especially if the lateral boundary is not exactly flat or straight, for example, if the lateral boundary has protrusions or projections protruding in the direction of the aisle due to the presence of dirt or minor damage.

A design of the present invention provides that, after or during the detection of an environment, computer-aided generation, in particular creating and saving, of a segmentation of the environment and/or of the detected objects can, for example, be effected. The environment detected by the industrial truck may in particular be divided into individual segments. Detected objects may be assigned to these segments. This makes it possible to ascertain a rough orientation in the environment, as well as an assignment and positioning of the detected objects in the environment, in particular relative to the currently recorded position of the industrial truck. The segmentation may optionally be displayed visually to the operator. Segmentation in this case means a division of the surrounding area into individual regions, in particular into smaller regions.

Segmentation can, for example, be effected via setting coordinates and/or measurement points. A computer-aided recording of coordinates and/or measurement points may, for example, be effected on the vehicle. This makes it possible to store and retrieve the assignment and positioning of objects in the environment.

It is also conceivable for the detected objects to be grouped depending on predefined criteria. The detected objects may, for example, be grouped into environment objects relevant for control of the aligning of the industrial truck and environment objects that are not relevant for control of the aligning of the industrial truck. Environment objects that are relevant for control may, for example, be the lateral boundary of a rack wall or an object located in the entry region. These objects may in particular affect the operational control for the aligning of the industrial truck. An environment object that is not relevant for control may, for example, be an object located further away that is not significant for the aligning of the industrial truck in front of an aisle entrance.

In a further design, the present invention provides that, after or during the detection of an environment, a computer-aided generation, in particular creating and saving, of a time-current local, in particular virtual, map of the environment can, for example, be effected. The creating and saving of the map may in particular be effected with the aid of a computer in the form of computer data. Information relating to an environment and to objects arranged therein can thus be collected, saved, and represented visually. It may of course also be provided that a map is predefined, for example, a building plan, and that the detected objects are entered subsequently.

It is conceivable for constantly recurring objects, such as a fixed lateral boundary of the rack wall, to be detected as such and recorded with a corresponding identifier in a mapping system. Real-time information relating to newly detected objects such as, for example, relocatable pallets or goods, may also be collected and entered into the map. To enable the information on the map to be used not only for current operational control of the industrial truck but also for subsequent or other industrial trucks, in particular for automatically aligning the industrial truck in the entry region, it may be provided that the information relating to the detected objects be transmitted via an interface to other industrial trucks and/or to a higher-order computer system, in particular located in the building, and to in turn be retrieved therefrom.

According to a design of the present invention, the automatic controlling of the industrial truck relates exclusively to operational control of the steering. This means that only the steering of the industrial truck is controlled automatically for the purpose of aligning in front of a rack aisle, while the accelerating and/or braking of the industrial truck is effected manually by the operator.

The present invention also relates to an industrial truck for performing the method described above. This vehicle may in particular have the design features (some of which have already been discussed above) for performing the method. For this purpose, there may in particular be a device for detecting the environment, in particular at least one detection sensor, as well as a computer-aided element for controlling the vehicle, in particular an automatic steering control, arranged on the industrial truck.

The drawings show diagrams (in purely schematic form) of two exemplary embodiments of the method according to the present invention, these being an industrial truck and an arrangement of rack aisles.

All of the drawings show a respective view of a racking system 100 or 200 from above. The racking system 100, 200 may be realized as a sub-section of a large racking system or mobile racking system, and in this case comprises two conventional racks 5, also known as rack walls. So-called rack aisles 2, 3, 4 extend in the usual manner between the racks 5, in particular along their longitudinal sides. The rack aisles 4 are in this case delimited by a rack 5 on one side only, the rack aisles 2 and 3 on both sides. The rack aisles 2, 3, 4 are used to store or retrieve goods into and out of the respective rack 5, and may in particular be driven on by an industrial truck 1. To save space, each rack aisle 2, 3, 4 is generally of a width that is only slightly greater than the width of the industrial truck 1 used for storage and retrieval, in particular the width of the industrial truck 1 in relation to its main direction of travel, which in the drawing is indicated by the arrow 10.

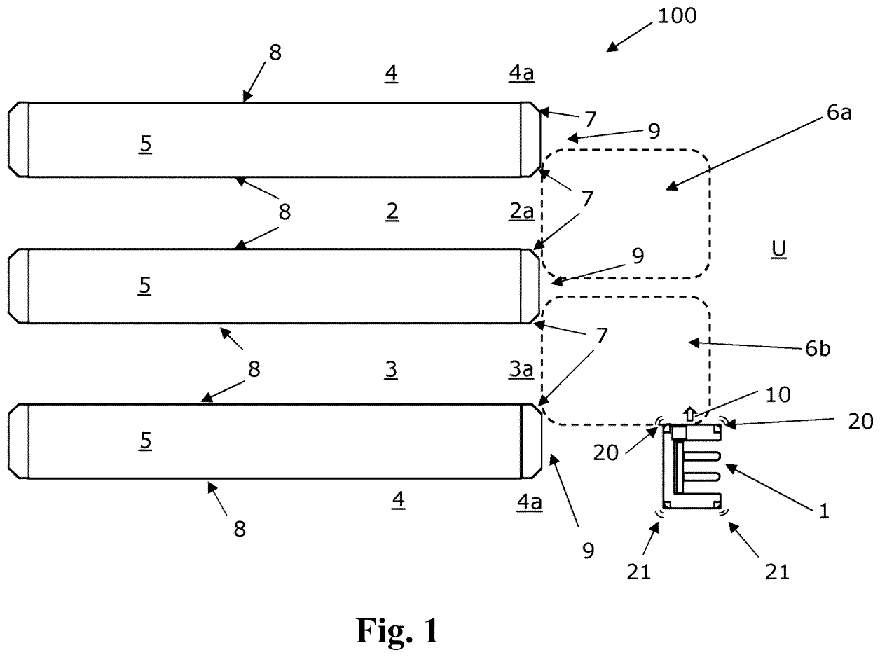

In particular when transitioning from an open area into such a relatively narrow rack aisle 2, 3, 4, in particular at the front ends 9 of the racks 5, as shown in the present drawings on both the right and left of the racks 5 and only identified as an example as a so-called entry region 6a, 6b in the right-hand part of the FIG. 1, it is not uncommon for there to be collisions with racks or their lateral boundaries due to inaccuracies in the alignment of the industrial truck 1. To protect the racks 5, reinforced funnel-shaped lateral boundaries 7, shown here as an example, are therefore generally provided, at least in the entry regions 6a, 6b, which prevent the industrial truck 1 from colliding with the rack 5 in the event of misalignment. Arranged here within the rack aisles 2, 3, 4 are further lateral boundaries 8 for guidance and/or for avoidance of collision with the rack 5.

The industrial truck 1 according to the present invention is here provided as a sideloader. This industrial truck 1 has a U-shaped chassis having a lift mast (not denoted by a reference numeral) which has two lift forks that are arranged in the transverse direction which are, for example, displaceable in this direction. The industrial truck may of course also be of a different design, and may in particular be provided as an conventional lift-mast truck, forklift truck, or as any other vehicle having a lift mast and forks. The industrial truck 1 has a running gear that is connected to the chassis and generally comprises at least three wheels or wheel arrangements, each being in particular mounted so as to be rotatable through 360°, of which two are usually driven. The industrial truck 1 is therefore very maneuverable and can generally turn around on the spot. An operator's control stand is usually arranged on a front lateral region that is arranged in the main direction of travel 10 for driving and operating the industrial truck 1, which for reasons of clarity is here not identified further.

A detection sensor 20, 21, for example, a distance sensor, is arranged in a front lateral region and in a rear lateral region, on the left and right side, of the industrial truck 1 with respect to the main direction of travel 10. The detection sensors 20 at the front in the main direction of travel 10 and the detection sensors 21 at the rear in the main direction of travel 10 serve to detect objects G located adjacent to the industrial truck 1. The detection sensors 20, 21 are here also suitable for detecting a respective distance between the industrial truck 1 and the detected object G. The detection sensors 20, 21 are, for example, realized as optical or run-time measurement sensors.

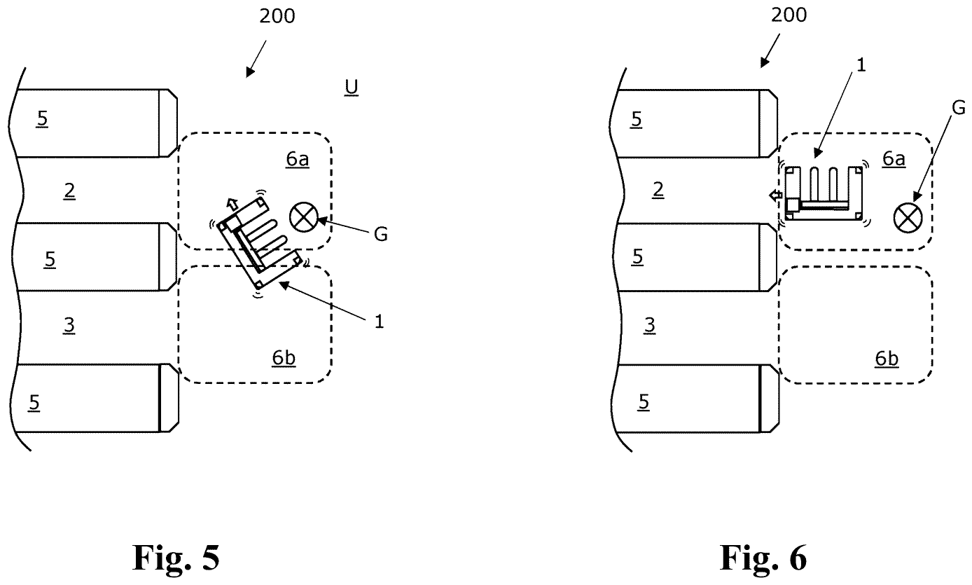

The industrial truck 1 shown here also has a control device (not shown in the drawings), in particular a computer unit, which uses detected and predefined data to determine a respectively least distance A between the industrial truck 1 and the detected object G, for example, if the least distance A from the object G is not in the range of the detection sensor 20, 21, but is in the range of the lifting forks. This enables a fast and precise detection of a distance A between the industrial truck 1 and an environment obstacle G such as, for example, in FIG. 1, from the lateral boundary 7, and in FIGS. 5 and 6, additionally from the object G. The detection sensors 20, 21 are each connected to the control device (not shown in the drawings) for automatically aligning the industrial truck 1, in particular by steering, accelerating, and/or braking the industrial truck 1.

To enable the industrial truck 1 to be driven into one of the rack aisles 2, 3, 4 in a particularly convenient and safe manner, the present invention provides that an automatic aligning of the industrial truck 1 into a predefined position, in particular in the direction of travel 10 in front of the respective rack aisle 2, 3, 4, is effected in the entry region 6a, 6b. To enable the aforementioned aligning to be performed particularly quickly and easily, the present invention additionally provides that objects G located adjacent to the industrial truck 1 are detected via the detection sensors 20, 21 described above, and that the aligning is enabled when an entrance 2a, 3a into a rack aisle 2, 3, 4 is recognized. The actual execution of the automatic aligning of the industrial truck 1 following enabling may be effected by an operator of the industrial truck 1 via a control command before the start of travel, in particular before detection of an entrance 2a, 3a, or alternatively via an individual confirmation following detection of an entrance 2a, 3a.

FIG. 1 shows, on a racking system 100, how the industrial truck 1 enters the rack aisle 3 in the entry region 6b of the rack aisle. Up to this point, the industrial truck 1 has monitored the environment U with respect to adjacent located objects G via the detection sensors 20, 21 in order to avoid collision. At the moment of entering the entry region 6b, the detection sensors 20, 21, in this case in particular the detection sensor 20 arranged at the front left of the industrial truck 1, detect the predefined features for the entrance 3a, such as, for example, a determined shape or color of the lateral boundary 7 located in this region, or an individual coding, such as a barcode, here arranged. An automatic aligning of the industrial truck 1 relative to the rack aisle 3 is thereby enabled.

In the example shown, enabling results in a visual indication to the operator of the industrial truck 1 that the entrance 3a has been detected and that automatic aligning of the industrial truck 1 is possible. The visual indication may in particular be effected by the illumination of a pushbutton or a display in the operator's control stand of the industrial truck 1. The operator may thereby manually issue a control command to perform the automatic aligning of the industrial truck 1, for example, by actuating the illuminated pushbutton or display.

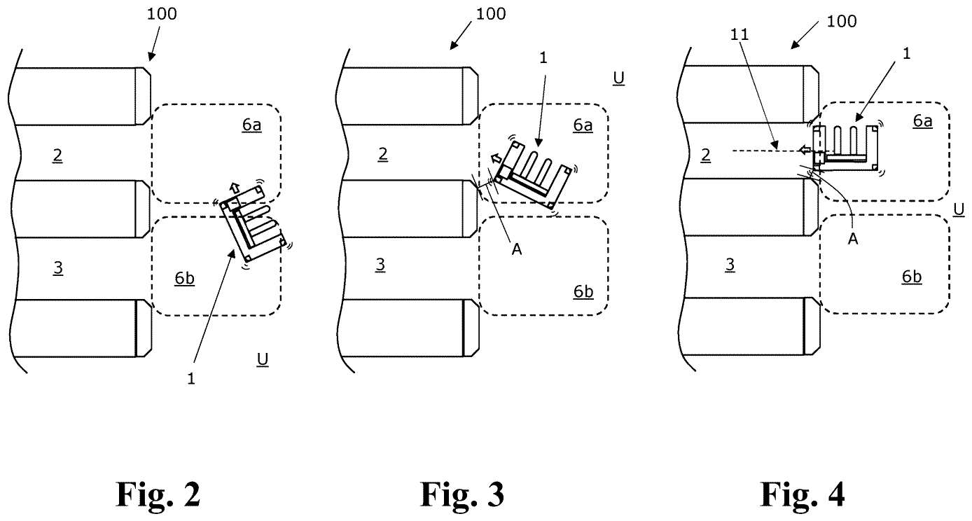

In this case, however, the industrial truck 1 is to be moved not into the rack aisle 3 but into the rack aisle 2. The operator accordingly does not press the illuminated pushbutton, but moves the industrial truck 1 further in the direction of the rack aisle 2, as represented in FIG. 2. In the process, the industrial truck 1 moves from the entry region 6b of the entrance 3a to the entry region 6a of the entrance 2a. The entry regions 6a, 6b may be color-marked for ease of orientation and to indicate a hazard area on a floor.

Upon exiting the entry region 6b, either the enabling for alignment can be cancelled, and consequently the pushbutton that illuminates at the entrance 3a can be extinguished and be held ready for the next message, or alternatively (in particular if there is a plurality of pushbuttons for visualizing and selecting an entrance) it may remain illuminated until the entrance 3a can no longer be detected by the detection sensors 20, 21.

As soon as the industrial truck 1 has entered the next entry region 6a, the features predefined for the entrance 2a are detected by the detection sensors 20, 21, and the automatic aligning of the industrial truck 1 relative to the rack aisle 2 is enabled. Via an illuminated pushbutton, the operator is again given the option of selecting the automatic aligning of the industrial truck 1, which is in this case confirmed by the operator.

For the purpose of aligning, a position of the industrial truck 1 relative to the rack aisle 2 is first determined via the detection sensors 20, 21 and the control device. This may in particular be effected by detecting and/or determining at least one distance A from the entrance. As shown in FIG. 3, the distance A between the detection sensor 20 and the lateral boundary 7 is here used for this purpose. In the case of the distance being determined computationally, the distance between the lateral boundary 7 and a vehicle center may, for example, be calculated. Further stored data may also be used to determine the location, or positioning, of the industrial truck 1, in particular retrieved from a (not shown) database.

With continuous monitoring of the environment U adjacent to the industrial truck 1 via the detection sensors 20, 21, the industrial truck 1 is moved, via automatic steering, acceleration and braking, into the position represented in FIG. 4. While the entrance 2a is being detected, a virtual center line 11 of the rack aisle 2 may here be determined or ascertained computationally. This virtual center line 11 may be used to guide the industrial truck 1 exactly in the mid-path of the rack aisle.

According to the example described above, the actual automatic aligning of the industrial truck 1 is effected only after confirmation by the operator (actuation of the pushbutton). If the operator has already confirmed automatic aligning of the industrial truck 1 before the start of travel, the industrial truck 1 would align the vehicle 1 according to the respective rack aisle 2, 3, 4 immediately after entering the entry region 6a, 6b. To avoid an unintentional aligning of the industrial truck 1, it may be provided that enabling is not yet effected upon entering the entry region 6a, 6b, but only when the distance from the detected entrance 2a, 3a becomes less than a predefined distance.

The enabling and/or an already commenced aligning of the industrial truck 1 may also be stopped, or at least adapted automatically, if an object G located in the movement range of the industrial truck 1 is detected, as shown in the case of the racking system 200 in FIG. 5. In this case, following the detection of the object G, a distance A from the object Gis first monitored via the detection sensors 20, 21 and the control device. If the industrial truck 1 comes too close to the object G, the automatic moving of the industrial truck 1 is stopped or, if the further distance A from the lateral boundary 7 permits, the industrial truck 1 is aligned by moving past the object until it has travelled to the position shown in FIG. 6.

The method described above in particular has the advantage that an automatic aligning of the industrial truck is effected entirely independently of other devices or specifications such as, for example, a navigation or guide-wire guidance system, but solely on the basis of the objects detected as being adjacent to the industrial truck at any given time. This means that there is no need for either any complex installation or intensive maintenance of the system. The method according to the present invention can rather be used flexibly and individually at any racking system.

The system provided in particular for aligning the industrial truck 1 may also be used to drive the industrial truck 1 automatically into and then along the corresponding rack aisle 2, 3, 4, in particular to steer it. The control of the industrial truck 1 may be effected, for example, depending on the detected distance from the lateral boundary 8 arranged along the rack 5 or depending on a generated virtual center line 11.

The system for aligning the industrial truck 1 may also be used in such an extended way that during each journey, an environment of the industrial truck 1, in particular objects G located adjacent to the industrial truck 1, are detected via the detection sensors 20, 21. An entire environment, or surroundings, of the industrial truck 1 may thereby be detected. The information obtained about the environment and the objects detected therein may be stored as electronic data, for example, in the control device or in another computer unit and used, for example, for subsequent journeys. For this purpose, it may be provided that the detected environment and/or the detected objects are divided into segments, in particular by setting coordinates or measurement points. Objects may also be assigned to differentiated groups, for example, depending on their size, shape or mobility, in particular to objects that are relevant for the aligning of the industrial truck 1 and objects that are not relevant for this aligning. An object located in the entrance 2a, 3a, may, for example, be classified as relevant for control, and an object located further away as not relevant for control. The funnel-shaped lateral boundary 7 arranged in the entrance 2a, 3a may also be grouped as a non-contact object, whereas a lateral boundary 8 realized as a guide bar, for example, within a rack aisle 2, 3, 4, may be grouped as a contact object.

All of this information may be used to compile a time-current map of the local environment which can be used at least by the control device to align the industrial truck 1. This may also be used to quickly and effectively detect an incorrect positioning of objects or damage to fixtures such as the lateral boundaries 7, 8.

It should be clear that the scope of protection of the present invention is not limited to the exemplary embodiment described. The structure of the industrial truck and of the racks may in particular be modified without altering the essence of the invention. Reference should also be had to the appended claims.

### LIST OF REFERENCE CHARACTERS

1 industrial truck
2 rack aisle
2a entrance
3 rack aisle
3a entrance
4 rack aisle
4a entrance
5 rack
6a entry region
6b entry region
7 lateral boundary
8 lateral boundary
9 front end
10 main direction of travel
11 virtual center line
20 detection sensor
21 detection sensor
100 racking system
200 racking system
A distance
G object
U environment

What is claimed is:

1-15. (canceled)

16. A method for automatically controlling an industrial truck when entering a rack aisle and when driving along at least one rack of a racking system, the method comprising:
driving over a predefined entry region of at least one rack aisle;
detecting an environment adjacent to the industrial truck via at least one optical and/or run-time measuring sensor; and
upon a detection of at least one predefined feature of an entrance into a selected rack aisle of the at least one rack aisle, enabling an automatic alignment of the industrial truck into a predefined position relative to the selected rack aisle.

17. The method as recited in claim 16, wherein,
the environment adjacent to the industrial truck comprises at least one object which is/are located adjacent to the industrial truck, and
the at least one predefined feature is a geometric feature.

18. The method as recited in claim 17, wherein the at least one object which is/are located adjacent to the industrial truck is a lateral boundary of the at least one rack aisle.

19. The method as recited in claim 17, wherein, after the environment adjacent to the industrial truck has been detected via the detection of the at least one object, the method further comprises:
determining or ascertaining a distance and/or a position of the industrial truck relative to the at least one object detected.

20. The method as recited in claim 17, wherein, after or during the detecting of the environment adjacent to the industrial truck, the method further comprises:
effecting a computer-aided generation of a segmentation of the environment detected and/or of a segmentation of the at least one object of the environment detected.

21. The method as recited in claim 20, where the effecting of the computer-aided generation comprises creating and saving the segmentation of the environment detected and/or of the segmentation of the at least one object of the environment detected.

22. The method as recited in claim 20, wherein the effecting of the segmentation is performed via setting coordinates and/or via measurement points.

23. The method as recited in claim 17, wherein, after the at least one object of the environment has been detected, the method further comprises:
effecting a computer-aided generation of a grouping of control-relevant environment objects and non-control-relevant environment objects.

24. The method as recited in claim 16, wherein the at least one optical and/or run-time measuring sensor via which the detecting of the environment is performed is a camera, a lidar, an electromagnetic radar-sensor, and/or an acoustic ultrasonic sensor.

25. The method as recited in claim 16, wherein, immediately following the enabling of the automatic alignment of the industrial truck into the predefined position relative to the selected rack aisle, the method further comprises:
effecting an automatic implementation of the enabled automatic alignment, or
indicating the enabling of the automatic alignment to an operator of the industrial truck so that the operator, via a control command, can manually select the automatic alignment of the industrial truck.

26. The method as recited in claim 25, further comprising:
detecting a plurality of possible entrances;
displaying the plurality of possible entrances to the operator for a selection of the automatic alignment of the industrial truck; and either,
the operator, via the control command, manually selecting one of the plurality of possible entrances in front of which the automatic alignment of the industrial truck is to be effected, or
automatically selecting an entrance of the plurality of possible entrances which is located closest to the industrial truck.

27. The method as recited in claim 16, wherein, upon the detection of the at least one predefined feature of the entrance, the method further comprises:
determining or ascertaining a distance of the industrial truck from the entrance detected.

28. The method as recited in claim 27, wherein the enabling of the automatic alignment of the industrial truck is effected when the distance of the industrial truck from the entrance detected is less than a predefined distance.

29. The method as recited in claim 16, wherein, after the detection of the least one predefined feature of the entrance into the at least one rack aisle and the enabling of the automatic alignment of the industrial truck into the predefined position relative to the selected rack aisle, the method further comprises:
automatically driving the industrial truck into the selected rack aisle.

30. The method as recited in claim 16, wherein, after the detection of the least one predefined feature of the entrance into the selected rack aisle, the method further comprises:
determining or ascertaining a center line which extends along a center of the selected rack aisle; and/or
determining or ascertaining a predefined distance from a rack wall of the selected rack aisle.

31. The method as recited in claim 16, wherein, after or during the detecting of the environment, the method further comprises:
effecting a computer-aided generation of a time-current local map of the environment.

32. The method as recited in claim 16, wherein the automatic controlling of the industrial truck relates exclusively to an operational control of a steering.

33. An industrial truck which is configured to perform the method as recited in claim 16.
